(19) United States
(12) Patent Application Publication
(10) Pub. No.: US 2012/0234452 A1
(43) Pub. Date: Sep. 20, 2012

(54) RUBBER COMPOSITION FOR BEAD APEX, AND PNEUMATIC TIRE

(76) Inventor: TATSUYA MIYAZAKI, KOBE-SHI (JP)

(21) Appl. No.: 13/421,917

(22) Filed: Mar. 16, 2012

(30) Foreign Application Priority Data
Mar. 17, 2011 (JP) 2011-059773
Nov. 11, 2011 (JP) 2011-247878

(51) Int. Cl. B60C 15/00; C08L 21/00; C08K 3/04

(52) U.S. Cl. 152/541; 524/495

(57) ABSTRACT

The present invention aims to provide a rubber composition for a bead apex and a pneumatic tire which are capable of improving the handling stability, fuel economy and extrusion processability in a balanced manner. The present invention relates to a rubber composition for a bead apex, including: a rubber component; carbon black; an inorganic filler other than silica; and a phenolic resin, wherein the carbon black has a BET specific surface area of 25 to 50 m²/g; and an amount of the carbon black is 40 to 80 parts by mass, and an amount of the inorganic filler is 3 to 30 parts by mass, based on 100 parts by mass of the rubber component.

### TECHNICAL FIELD

The present invention relates to a rubber composition for a bead apex, and a pneumatic tire using the same.

### BACKGROUND ART

Conventional rubber compositions for tire bead apexes have been designed especially to increase the complex elastic modulus (E*) and improve the handling stability (e.g. steering response). However, even if the handling stability is improved, in the case of driving with tires for sport utility vehicles (SUVs) or driving at cold temperatures, deformation strain is stored in the bead apexes of the tires, that is, a flat spot develops, until the tire temperature is increased after the vehicle stops for a certain period of time and then restarts running. As a result, the fuel economy is deteriorated. Such a flat spot can be effectively prevented by reducing the tan δ.

In order to increase the E*, 1,2-syndiotactic polybutadiene (SPB) crystals may be added to a rubber composition, for example. In this case, however, the tan δ tends to increase, and the fuel economy tends to deteriorate. On the other hand, in order to reduce the tan δ, carbon black having a comparatively large particle size, such as N550, may be used, the amount of filler such as carbon black may be reduced, or the amount of oil may be reduced. In such a case, however, the E* tends to decrease, and the handling stability tends to deteriorate. In addition, problematically, for example, the extrusion processability may be deteriorated, the rubber shape is more likely to change with time, or the rubber extrudate after extrusion processing may not provide a uniform edge profile. Thus, the handling stability, fuel economy, and extrusion processability are conflicting properties, and these performances are difficult to improve in a balanced manner.

As a technique to solve these problems, Patent Document 1 discloses adding a (modified) phenol resin and sulfur to a rubber component including natural rubber and the like. However, there is a need for further improvement in the handling stability, fuel economy, and extrusion processability.

Patent Document 1: JP 2007-302865 A

### SUMMARY OF THE INVENTION

The present invention aims to provide a rubber composition for a bead apex and a pneumatic tire which are capable of overcoming the above problems, and improving the handling stability, fuel economy, and extrusion processability in a balanced manner.

The present invention relates to a rubber composition for a bead apex, including: a rubber component; carbon black; an inorganic filler other than silica; and a phenolic resin, wherein the carbon black has a BET specific surface area of 25 to 50 m²/g; and an amount of the carbon black is 40 to 80 parts by mass, and an amount of the inorganic filler is 3 to 30 parts by mass, based on 100 parts by mass of the rubber component.

The rubber composition preferably further includes: an alkylphenol-sulfur chloride condensate represented by formula (1):

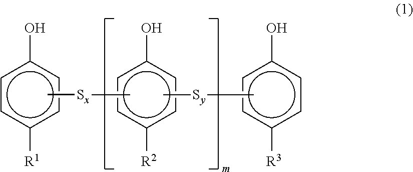

wherein R¹, R², and R³ are the same as or different from one another, and each represent a C₅₋₁₂ alkyl group, x and y are the same as or different from one another, and each represent an integer of 1 to 3, and m represents an integer of 0 to 250.

The inorganic filler preferably has an average particle size of 100 μm or smaller.

The phenolic resin is preferably a phenol resin and/or a modified phenol resin.

A total amount of the phenol resin and modified phenol resin is preferably 5 to 18 parts by mass based on 100 parts by mass of the rubber component.

Preferably, a total amount of the carbon black, the inorganic filler, and silica is 50 to 120 parts by mass, a sulfur amount is 4 to 8 parts by mass, and an oil amount is not more than 5 parts by mass, based on 100 parts by mass of the rubber component.

The present invention also relates to a pneumatic tire, including a bead apex produced from the rubber composition.

The rubber composition for a bead apex of the present invention contains a rubber component, a carbon black having a specific BET specific surface area, an inorganic filler other than silica, and a phenolic resin. This composition can improve the handling stability, fuel economy, and extrusion processability in a balanced manner. Accordingly, a pneumatic tire excellent in these performances can be provided.

### BEST MODE FOR CARRYING OUT THE INVENTION

The rubber composition for a bead apex of the present invention includes: a rubber component; carbon black; an inorganic filler other than silica; and a phenolic resin, wherein the carbon black has a BET specific surface area of 25 to 50 m²/g; and an amount of the carbon black is 40 to 80 parts by mass, and an amount of the inorganic filler is 3 to 30 parts by mass, based on 100 parts by mass of the rubber component.

The rubber component may include a diene rubber(s) such as natural rubber (NR), isoprene rubber (IR), butadiene rubber (BR), styrene butadiene rubber (SBR), acrylonitrile butadiene rubber (NBR), chloroprene rubber (CR), and butyl rubber (IIR). Especially, NR, IR, BR, and SBR are preferable because they can suitably improve the handling stability, fuel economy, and extrusion processability. More preferable are a combination of NR, BR, and SBR, and a combination of NR, IR, and SBR.

The BR is not particularly limited, and examples thereof include BR with a high cis-content, and syndiotactic polybutadiene crystal-containing BR (SPB-containing BR). Especially, SPB-containing BR is preferable for significant improvement in extrusion processability due to the inherent orientation of the crystals.

In the case where the rubber component includes SPB-containing BR, the SPB content of the SPB-containing BR is preferably not less than 8% by mass, and more preferably not less than 12% by mass. An SPB content of less than 8% by mass may result in an insufficient effect of improving the extrusion processability. The SPB content is preferably not more than 20% by mass, and more preferably not more than 18% by mass. An SPB content of more than 20% by mass tends to result in lower extrusion processability.

The SPB content of SPB-containing BR is given as the amount of boiling n-hexane-insoluble matter.

Examples of the SBR include, but not particularly limited to, emulsion-polymerized styrene butadiene rubber (E-SBR) and solution-polymerized styrene butadiene rubber (S-SBR). Especially, E-SBR is preferable because it allows good dispersion of carbon black and provides good processability.

The styrene content of the SBR is preferably not less than 10% by mass, and more preferably not less than 20% by mass. A styrene content of less than 10% by mass tends to result in insufficient hardness. The styrene content is preferably not more than 40% by mass, and more preferably not more than 30% by mass. A styrene content of more than 40% by mass tends to lead to poor fuel economy.

The amount of NR is preferably not less than 20% by mass, and more preferably not less than 40% by mass, in 100% by mass of the rubber component. An amount of less than 20% by mass may result in insufficient tensile strength. The amount is preferably not more than 80% by mass, and more preferably not more than 60% by mass. An amount of more than 80% by mass may result in insufficient hardness, and also tends to lead to a fast curing rate so that the rubber composition is likely to scorch when extruded.

The amount of IR is preferably not less than 5% by mass, and more preferably not less than 15% by mass, in 100% by mass of the rubber component. An amount of less than 5% by mass tends to result in an insufficient effect of improving the processability. The amount is preferably not more than 50% by mass, and more preferably not more than 30% by mass. An amount of more than 50% by mass tends to result in poor elongation at break compared to NR.

The amount of BR is preferably not less than 5% by mass, and more preferably not less than 15% by mass, in 100% by mass of the rubber component. An amount of less than 5% by mass may result in insufficient durability. The amount is preferably not more than 50% by mass, and more preferably not more than 30% by mass. An amount of more than 50% by mass tends to result in poor extrusion processability and poor elongation at break.

The amount of SBR is preferably not less than 15% by mass, and more preferably not less than 25% by mass, in 100% by mass of the rubber component. An amount of less than 15% by mass may lead to insufficient improvement in extrusion processability and also result in insufficient hardness. The amount is preferably not more than 60% by mass, and more preferably not more than 40% by mass. An amount of more than 60% by mass tends to lead to poor fuel economy.

The rubber composition of the present invention contains a carbon black having a specific BET specific surface area.

The BET specific surface area of the carbon black is not less than 25 m²/g, preferably not less than 35 m²/g, and more preferably not less than 40 m²/g. A BET specific surface area of less than 25 m²/g may lead to insufficient improvement in handling stability. The BET specific surface area is not more than 50 m²/g, and preferably not more than 45 m²/g. A BET specific surface area of more than 50 m²/g tends to lead to poor fuel economy.

The BET specific surface area of carbon black herein is determined in accordance with ASTM D 6556.

The COAN (compressed oil absorption number) of the carbon black is preferably not less than 85 ml/100 g, and more preferably not less than 100 ml/100 g. A COAN of less than 85 ml/100 g may lead to insufficient improvement in handling stability. The COAN is preferably not more than 130 ml/100 g and more preferably not more than 120 ml/100 g. A COAN of more than 130 ml/100 g tends to lead to poor fuel economy.

The COAN of carbon black herein is determined in accordance with ASTM D3493. Dibutyl phthalate (DBP) is used as oil.

The DBP oil absorption (OAN) of the carbon black is preferably not less than 100 ml/100 g, and more preferably not less than 130 ml/100 g. A DBP oil absorption of less than 100 ml/100 g may lead to an insufficient effect of improving the handling stability. The DBP oil absorption is preferably not more than 250 ml/100 g, and more preferably not more than 200 ml/100 g. A DBP oil absorption of more than 250 ml/100 g tends to result in poor fuel economy.

The DBP oil absorption (OAN) of carbon black herein is determined in accordance with ASTM D2414.

The carbon black can be produced by conventionally known methods such as the furnace process and channel process.

The amount of the carbon black is not less than 40 parts by mass, preferably not less than 55 parts by mass, and more preferably not less than 65 parts by mass, based on 100 parts by mass of the rubber component. An amount of less than 40 parts by mass may lead to insufficient improvement in handling stability. The amount is not more than 80 parts by mass, and preferably not more than 77 parts by mass, based on 100 parts by mass of the rubber component. An amount of more than 80 parts by mass may lead to low dispersibility of the carbon black and insufficient fuel economy. In addition, in this case, much heat is generated in extrusion, so that scorch is likely to occur and the extrudate tends to have a problem in the edge profile.

The rubber composition of the present invention contains an inorganic filler other than silica. By containing the inorganic filler, the extrusion processability can be improved while the handling stability and fuel economy are favorably maintained. In other words, these performances can be improved in a balanced manner.

Examples of the inorganic filler include calcium carbonate, talc, hard clay, Austin black, fly ash, and mica. Calcium carbonate and talc are preferable among these because they are less likely to act as rupture nuclei in running due to their low self-aggregation, thereby leading to good durability, and also because they exert a large effect of improving the extrusion processability (particularly, edge smoothness of extrudate). It is presumed that calcium carbonate exerts such an excellent effect by acting similarly to SPB in the SPB-containing BR. Also, talc is favorable in terms of processability because it has a Mohs hardness of 1 and thus is the softest among these.

The average particle size (average primary particle size) of the inorganic filler is preferably not larger than 100 μm, more preferably not larger than 50 μm, and further preferably not larger than 30 μm. If it exceeds 100 μm, the inorganic filler is likely to act as rupture nuclei in running and tends to lead to low durability. The average particle size of the inorganic filler is preferably not smaller than 1 μm, and more preferably not smaller than 2 μm. If it is less than 1 μm, the processability in extrusion may not be improved sufficiently.

The average particle size of an inorganic filler as used herein is a value determined by a laser diffraction/scattering method (Microtrac method).

The amount of the inorganic filler is not less than 3 parts by mass, preferably not less than 10 parts by mass, and more preferably not less than 12 parts by mass, based on 100 parts by mass of the rubber component. An amount of less than 3 parts by mass may lead to insufficient improvement in extrusion processability. The amount is not more than 30 parts by mass, and preferably not more than 20 parts by mass, based on 100 parts by mass of the rubber component. An amount of more than 30 parts by mass tends to lead to an increase in tan δ and reduction in tensile strength.

In the case of a rubber composition containing silica, even when the composition is extruded straightly in extrusion, the edge portion of the bead apex obtained tends to shrink with time and deform (bend) down. In addition, a rubber composition containing silica tends not to improve the extrusion processability as sufficiently as other inorganic fillers. Further, since silica is poorly compatible with phenolic resins, the E* (Hs) may not be sufficiently increased. Therefore, the amount of silica is preferably as small as possible. In the rubber composition of the present invention, the amount of silica is preferably not more than 5 parts by mass, more preferably not more than 1 part by mass, and further preferably 0 parts by mass (substantially silica-free), based on 100 parts by mass of the rubber component.

The total amount of the carbon black, the inorganic filler, and silica is preferably not less than 50 parts by mass, and more preferably not less than 70 parts by mass, based on 100 parts by mass of the rubber component. The total amount is preferably not more than 120 parts by mass, and more preferably not more than 110 parts by mass. The total amount within this range can lead to balanced improvement in the handling stability, fuel economy, and extrusion processability at high levels.

The rubber composition of the present invention contains a phenolic resin, and examples of the phenolic resin include phenol resins, modified phenol resins, cresol resins, and modified cresol resins. The term “phenol resin” is intended to include those obtained by the reaction between phenol and an aldehyde such as formaldehyde, acetaldehyde or furfural in the presence of an acid or alkali catalyst. The term “modified phenol resin” is intended to include phenol resins modified with a compound such as cashew oil, tall oil, linseed oil, an animal or vegetable oil of any type, an unsaturated fatty acid, rosin, alkylbenzene resin, aniline, or melamine.

The phenolic resin preferably includes a modified phenol resin. In this case, larger composite spheres are formed, or harder composite spheres are formed because more sufficient hardness is provided as a result of the curing reaction. In particular, a cashew oil-modified phenol resin or rosin-modified phenol resin is more preferable.

Suitable examples of the cashew oil-modified phenol resin include those represented by formula (2).

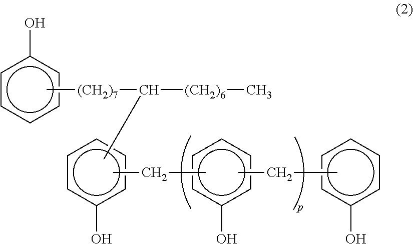

In formula (2), p is an integer of 1 to 9, and preferably 5 or 6 for high reactivity and improved dispersibility.

The phenolic resin preferably further includes a non-reactive alkylphenol resin in addition to a phenol resin and/or a modified phenol resin. The non-reactive alkylphenol resin is highly compatible with the phenol resin and modified phenol resin and prevents composite spheres formed from the phenolic resin and filler from softening, so that deterioration of the handling stability can be suppressed. In addition, good extrusion processability (in particular, adhesion) is provided. The term “non-reactive alkylphenol resin” is intended to include alkylphenol resins free from reactive sites ortho and para (in particular, para) to the hydroxyl groups of the benzene rings in the chain. Suitable examples of the non-reactive alkylphenol resin include those represented by formulae (3) and (4).

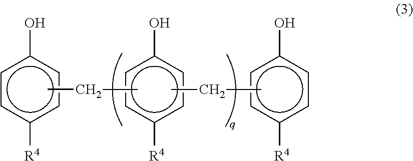

In formula (3), q is an integer, and is preferably 1 to 10, and more preferably 2 to 9 for adequate blooming resistance. R⁴s, which may be the same as or different from one another, each represent an alkyl group, and preferably represent a C₄₋₁₅ alkyl group, and more preferably a C₆₋₁₀ alkyl group for compatibility with rubber.

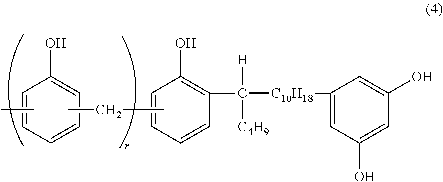

In formula (4), r is an integer, and is preferably 1 to 10, and more preferably 2 to 9 for adequate blooming resistance.

The total amount of the phenol resin and modified phenol resin is preferably not less than 5 parts by mass, and more preferably not less than 8 parts by mass, based on 100 parts by mass of the rubber component. A total amount of less than 5 parts by mass may result in insufficient hardness. The total amount is preferably not more than 18 parts by mass, and more preferably not more than 16 parts by mass, based on 100 parts by mass of the rubber component. An amount of more than 18 parts by mass tends to lead to poor fuel economy.

The amount of the non-reactive alkylphenol resin is preferably not less than 1 part by mass, and more preferably not less than 2 parts by mass, based on 100 parts by mass of the rubber component. An amount of less than 1 part by mass may result in insufficient adhesion. The amount is preferably not more than 7 parts by mass, and more preferably not more than 5 parts by mass, based on 100 parts by mass of the rubber component. An amount of more than 7 parts by mass tends to lead to poor fuel economy and may result in insufficient hardness.

The amount of the phenolic resin (the total amount of the above resins) is preferably not less than 5 parts by mass, and more preferably not less than 8 parts by mass, based on 100 parts by mass of the rubber component. An amount of less than 5 parts by mass may result in insufficient hardness. The amount is preferably not more than 30 parts by mass, and more preferably not more than 25 parts by mass, based on 100 parts by mass of the rubber component. An amount of more than 30 parts by mass tends to lead to poor fuel economy.

The rubber composition of the present invention typically contains a curing agent for curing the phenolic resin. The use of a curing agent results in formation of composite spheres in which the phenolic resin is cross-linked. As a result, the effects of the present invention are favorably provided. The curing agent is not particularly limited, provided that it has the curing ability mentioned above. Examples thereof include hexamethylenetetramine (HMT), hexamethoxymethylol melamine (HMMM), hexamethylol melamine pentamethyl ether (HMMPME), melamine, and methylol melamine. Especially, HMT, HMMM, and HMMPME are preferable because of their high ability to increase the hardness of the phenolic resin.

The amount of the curing agent is preferably not less than 1 part by mass, and more preferably not less than 5 parts by mass, based on 100 parts by mass of the total amount of the phenol resin and modified phenol resin. An amount of less than 1 part by mass may cause insufficient curing. The amount is preferably not more than 20 parts by mass, and more preferably not more than 15 parts by mass, based on 100 parts by mass of the total amount of the phenol resin and modified phenol resin. An amount of more than 20 parts by mass may cause non-uniform curing, and may result in scorch in extrusion.

The rubber composition of the present invention preferably contains an alkylphenol-sulfur chloride condensate represented by the following formula (1). When the rubber composition contains the alkylphenol-sulfur chloride condensate, as well as a carbon black having a specific BET specific surface area, an inorganic filler other than silica, and a phenolic resin, a more thermally stable crosslinked structure can be formed in comparison with the case of usual sulfur crosslinking. In this case, not only the handling stability, fuel economy, and extrusion processability but also durability can be improved. Compared with other crosslinking agents such as PERKALINK900 (1,3-bis(citraconimidomethyl)benzene, product of Flexsys) and DURALINK HTS (sodium 1,6-hexamethylene dithiosulfate dihydrate, product of Flexsys), the alkylphenol-sulfur chloride condensate exerts higher effects of improving performances, and in particular, it can increase the E*, thereby greatly improving the handling stability.

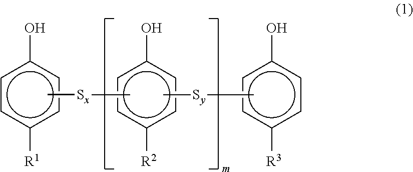

(wherein R¹, R², and R³ are the same as or different from one another, and each represent a C₅₋₁₂ alkyl group, x and y are the same as or different from one another, and each represent an integer of 1 to 3, and m represents an integer of 0 to 250.)

From the viewpoint of good dispersibility of the alkylphenol-sulfur chloride condensate in the rubber component, m is an integer of 0 to 250, preferably an integer of 0 to 100, and more preferably an integer of 20 to 50. From the viewpoint of efficient achievement of high hardness (reversion inhibition), x and y are each an integer of 1 to 3 and preferably 2. From the viewpoint of good dispersibility of the alkylphenol-sulfur chloride condensate in the rubber component, R¹ to R³ are each a C₅₋₁₂ alkyl group and preferably a C₆₋₉ alkyl group.

The alkylphenol-sulfur chloride condensate can be prepared by a known method, and the method is not particularly limited. Examples thereof include a method of reacting an alkylphenol and sulfur chloride at a molar ratio of 1:0.9-1.25.

Specific examples of the alkylphenol-sulfur chloride condensate include Tackirol V200 produced by Taoka Chemical Co., Ltd. (formula (1a)).

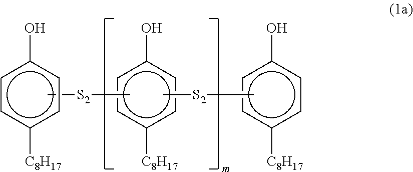

In formula (1a), m represents an integer of 0 to 100.

Here, the sulfur content of the alkylphenol-sulfur chloride condensate is a proportion determined by heating the condensate to 800-1000° C. in a combustion furnace for conversion into SO₂ gas or SO₃ gas, and then optically determining the amount of sulfur from the gas yield.

The amount of the alkylphenol-sulfur chloride condensate is preferably not less than 0.5 parts by mass, and more preferably not less than 1.0 part by mass, based on 100 parts by mass of the rubber component. An amount of less than 0.5 parts by mass may lead to an insufficient effect caused by blending the alkylphenol-sulfur chloride condensate. The amount is preferably not more than 2.5 parts by mass, and more preferably not more than 1.8 parts by mass, based on 100 parts by mass of the rubber component. An amount of more than 2.5 parts by mass may lead to reduction in elongation at break.

The rubber composition of the present invention may optionally contain compounding ingredients conventionally used in the rubber industry, in addition to the aforementioned ingredients. Examples of the compounding ingredients include oil, stearic acid, various antioxidants, zinc oxide, sulfur, vulcanization accelerators, and retarders.

In the present invention, excellent extrusion processability can be achieved without oil by using a specific carbon black, an inorganic filler other than silica, and a phenolic resin in combination and optionally using a specific alkylphenol-sulfur chloride condensate. Therefore, the amount of oil can be reduced, and higher levels of fuel economy and handling stability can be achieved. The amount of oil is preferably not more than 5 parts by mass, more preferably not more than 1 part by mass, and further preferably 0 parts by mass (substantially oil-free), based on 100 parts by mass of the rubber component.

The rubber composition of the present invention typically contains sulfur. For high handling stability, the amount of sulfur is preferably not less than 4 parts by mass, and more preferably not less than 5 parts by mass, based on 100 parts by mass of the rubber component. The amount is preferably not more than 8 parts by mass, and more preferably not more than 7 parts by mass in terms of blooming of sulfur, adhesion, and durability.

The amount of sulfur herein refers to the amount of pure sulfur, and refers, in the case of insoluble sulfur, to the amount of sulfur excluding oil.

The rubber composition of the present invention typically contains a vulcanization accelerator. The amount of the vulcanization accelerator is preferably not less than 1.5 parts by mass, and more preferably not less than 2.0 parts mass, but is preferably not more than 3.5 parts by mass, more preferably not more than 3.0 parts by mass, and further preferably not more than 2.8 parts by mass, based on 100 parts by mass of the rubber component. If the amount is within the range, the handling stability, fuel economy, and extrusion processability can be improved at high levels in a balanced manner.

Known methods can be employed as the method for producing the rubber composition of the present invention, and for example, the rubber composition may be produced by mixing and kneading the ingredients mentioned above with use of a rubber kneader such as an open roll mill or a Banbury mixer, and then vulcanizing the mixture.

The rubber composition of the present invention is used for a bead apex that is a component placed on the inner side of a clinch of a tire and extending radially outwardly from a bead core. Specifically, it is used, for example, for the components shown in FIGS. 1 to 3 of JP 2008-38140 A, and FIG. 1 of JP 2004-339287 A.

The pneumatic tire of the present invention can be produced by usual methods using the rubber composition. Specifically, before vulcanization, the rubber composition is extruded and processed into the shape of a bead apex, molded in a usual manner on a tire building machine, and then assembled with other tire components so as to form an unvulcanized tire. Then, the unvulcanized tire is heated and pressurized in a vulcanizer to produce a tire.

The pneumatic tire of the present invention can be used for passenger vehicles, heavy-load vehicles, motocross vehicles, and the like, and can be suitably used for motocross vehicles, in particular.

### EXAMPLES

The following will mention the present invention specifically with reference to examples, but the present invention is not limited thereto.

The chemical agents used in Examples and Comparative Examples are listed below.

NR: TSR20

IR: Nipol IR2200 produced by Zeon Corporation

BR1: VCR617 produced by Ube Industries, Ltd. (SPB-containing BR, ML₁₊₄ (100° C.): 62, amount of boiling n-hexane-insoluble matter: 17% by mass)

BR2: BR150-B produced by Ube Industries, Ltd.

SBR: Emulsion-polymerized SBR (E-SBR) 1502 produced by JSR Corp. (styrene content: 23.5% by mass)

Carbon black: see Table 1

Calcium carbonate: TANCAL 200 produced by Takehara Kagaku Kogyo Co., Ltd. (average particle size: 7.0 μm)

Talc: Mistron Vapor produced by Nihon Mistron Co., Ltd. (average particle size: 5.5 μm)

Austin black: Austin Black produced by Coal Fillers (carbon content: 77% by mass, oil content: 17% by mass, average particle size: 5 μm)

Hard clay: Crown Clay produced by Southeastern Clay Co. (average particle size: 0.6 μm)

Silica: Z115Gr produced by Rhodia

Alkylphenol resin: SP1068 produced by NIPPON SHOKUBAI Co., Ltd. (non-reactive alkylphenol resin represented by formula (3) (q: integer of 1 to 10, R⁴: octyl group))

Antioxidant: Nocrac 6C (6PPD) produced by Ouchi Shinko Chemical Industrial Co., Ltd.

Stearic acid: product of NOF Corporation

Zinc oxide: product of Mitsui Mining & Smelting Co., Ltd.

Sulfur: CRYSTEX HS OT20 produced by FLEXSYS (insoluble sulfur containing 80% by mass of sulfur and 20% by mass of oil)

Vulcanization accelerator TBBS: Nocceler NS produced by Ouchi Shinko Chemical Industrial Co., Ltd. (N-tert-butyl-2-benzothiazolylsulfenamide)

CTP: N-cyclohexylthio-phthalamide (CTP) produced by Ouchi Shinko Chemical Industrial Co., Ltd.

Modified phenol resin: PR12686 produced by Sumitomo Bakelite Co., Ltd. (cashew oil-modified phenol resin represented by formula (2))

V200: Tackirol V200 produced by Taoka Chemical Co., Ltd. (alkylphenol-sulfur chloride condensate represented by formula (1) (m: 0 to 100, x and y: 2, R¹ to R³: C₈H₁₇ (octyl group)), sulfur content: 24% by mass)

PK900: PERKALINK900 produced by Flexsys (1,3-bis(citraconimidomethy)benzene)

HTS: DURALINK HTS produced by Flexsys (sodium 1,6-hexamethylene dithiosulfate dihydrate)

HMT (curing agent): Nocceler H produced by Ouchi Shinko Chemical Industrial Co., Ltd. (hexamethylenetetramine)

TABLE 1

| | | COAN | BET | OAN |
|---|---|---|---|---|
| | | (ml/ | (NSA) | (ml/ |
| | | 100 g) | (m²/g) | 100 g) |
| Carbon black 1 | EB247 (Evonik) | 102 | 42 | 178 |
| Carbon black 2 | N351H (Mitsubishi | 102 | 68 | 137 |
| | Chemical Corporation) | | | |
| Carbon black 3 | N330 (Colombia Chemical) | 88 | 78 | 102 |
| Carbon black 4 | N550 (Jiangxi Black Cat | 88 | 40 | 122 |
| | Carbon Black Co., Ltd.) | | | |

### Examples and Comparative Examples

The materials in amounts shown in Table 2 or 3, except the sulfur, vulcanization accelerator, V200, PK900, HTS, and curing agent, were kneaded in a 1.7-L Banbury mixer at 150° C. for 5 minutes to give a kneaded mixture. Thereafter, the sulfur, vulcanization accelerator, V200, PK900, HTS, and curing agent as shown in Table 2 or 3 were added to the kneaded mixture, and then the resulting mixture was kneaded with an open roll mill at 80° C. for 3 minutes to give an unvulcanized rubber composition. A portion of the unvulcanized rubber composition was press-vulcanized in a 2-mm-thick mold at 150° C. for 30 minutes to give a vulcanized rubber composition.

Another portion of the unvulcanized rubber composition was molded into the shape of a bead apex. The molded product was assembled with other tire components into an unvulcanized tire, and the tire was press-vulcanized at 170° C. for 12 minutes to give a tire for sport utility vehicles (SUVs) (SUV tire, size: P265/65R17 110S).

The obtained unvulcanized rubber compositions, vulcanized rubber compositions, and SUV tires (new; and after break-in) were evaluated as follows. Tables 2 and 3 show the results.

### (Viscoelasticity Test)

The complex elastic modulus (E*) and loss tangent (tan δ) were measured for test samples prepared from the SUV tires using a viscoelasticity spectrometer (VES produced by Iwamoto Seisakusho Co., Ltd.) under the following conditions: a temperature of 70° C.; a frequency of 10 Hz; an initial strain of 10%; and a dynamic strain of 2%. A larger E* corresponds to higher rigidity and better handling stability; and a smaller tan δ corresponds to better fuel economy.

### (Handling Stability (Steering Response))

Each set of tires was mounted on a vehicle, the vehicle was driven on a dry asphalt test course (road surface temperature: 25° C.), and the handling stability (response of each vehicle to a minute change in the steering angle) during the driving was evaluated on a six-point scale based on sensory evaluation by a test driver. A higher point corresponds to better handling stability. The points “4+” and “6+” mean levels slightly higher than those of 4 and 6, respectively.

### (Rolling Resistance Test)

The rolling resistance was measured when the SUV tires (P265/65R17 1105, 17×7.5) were run at 25° C. on a drum under the following conditions: a load of 4.9 N; a tire internal pressure of 2.00 kPa; and a speed of 80 km/hour. The rolling resistance of the tire of Comparative Example 1 was used as the baseline, and the rolling resistance of the tire of each composition was expressed as an index relative to that of Comparative Example 1 by the following equation.

A larger negative index (smaller index) corresponds to more improved performance in terms of rolling resistance. (Rolling resistance reduction ratio)={(rolling resistance of each composition)−(rolling resistance of Comparative Example 1)}/(rolling resistance of Comparative Example 1)×100

### (Durability Index)

Each SUV tire was run on a drum under the conditions of a speed of 20 km/h, a 230% load of the maximum load (maximum internal pressure conditions) specified in the JIS standard. Then, the running distance until the bead apex portion swelled was determined. The determined value of running distance of the tire of each composition was expressed as an index relative to the determined value of running distance of Comparative Example 1 regarded as 100. A larger index corresponds to better durability, indicating more favorable performance.

(Durability index)=(running distance of each composition)/(running distance of Comparative Example 1)×100

### (Index of Straightness of Extrudate)

A portion of each unvulcanized rubber composition was extrusion-molded using an extrusion molding machine. The extruded unvulcanized rubber composition was molded into a certain shape of a bead apex, and the molded product was evaluated for its end warpage by visual observation. A five-point scale evaluation (point: 1 to 5) was performed for the warpage evaluation. Specifically, “5” indicates a condition with a lowest warpage (i.e. perpendicular to bead wires); and “1” indicates a condition with a highest warpage. The evaluation point of each composition was expressed as an index relative to that of Comparative Example 1 regarded as 100. Accordingly, a larger index corresponds to better extrusion processability.

### (Index of Edge Smoothness of Extrudate)

A portion of each unvulcanized rubber composition was extrusion-molded using an extrusion molding machine. The extruded unvulcanized rubber composition was molded into a certain shape of a bead apex, and the molded product was evaluated for its edge conditions by visual observation. A five-point scale evaluation (point: 1 to 5) was performed for the edge profile evaluation. Specifically, “5” indicates a condition with a straightest and smoothest edge; and “1” indicates a condition with a most irregular edge. The evaluation point of each composition was expressed as an index relative to that of Comparative Example 1 regarded as 100. Accordingly, a larger index corresponds to better extrusion processability.

### (Adhesion Index)

A portion of each unvulcanized rubber composition was extrusion-molded into a bead apex. The molded product was evaluated for adhesion between the rubber surface of the molded product and a carcass cord-covering rubber composition for tires (both adhesion and flatness) based on sensory evaluation by a molding operator, and the result was expressed as an index. A larger adhesion index corresponds to higher adhesion between the carcass and the bead apex and better molding processability. A smaller adhesion index corresponds to higher frequencies of separation between the carcass and the bead apex, and trapped air.

Generally, the adhesion depends on factors such as the extrusion temperature of a molded product (self-heating temperature), the type of an adhesive resin and the amount thereof, the type of a rubber component and the amount thereof.

TABLE 2

| | | Examples | | | | | |
|---|---|---|---|---|---|---|---|
| | | 1 | 2 | 3 | 4 | 5 | 6 |
| Composition | NR | 50 | 50 | 50 | 50 | 50 | 50 |
| (part(s) | IR | — | — | — | — | — | — |
| by mass) | BR1 (VCR617) | — | — | — | — | — | — |
| | BR2 (BR150B) | 20 | 20 | 20 | 20 | 20 | 20 |
| | SBR | 30 | 30 | 30 | 30 | 30 | 30 |
| | Carbon black 1 (EB247) | — | — | — | 65 | — | — |
| | Carbon black 2 (N351H) | — | — | — | — | — | — |
| | Carbon black 3 (N330) | — | — | — | — | — | — |
| | Carbon black 4 (N550) | 75 | 75 | 75 | — | 75 | 75 |
| | Calcium carbonate | 15 | 5 | 28 | 15 | 15 | 15 |
| | Talc | — | — | — | — | — | — |
| | Austin black | — | — | — | — | — | — |
| | Hard clay | — | — | — | — | — | — |
| | Silica | — | — | — | — | — | — |
| | Alkylphenol resin | 3 | 3 | 3 | 3 | 3 | 3 |
| | Antioxidant 6PPD | 1 | 1 | 1 | 1 | 1 | 1 |
| | Stearic acid | 3 | 3 | 3 | 3 | 3 | 3 |
| | Zinc oxide | 10 | 10 | 10 | 10 | 10 | 10 |
| | Sulfur | 7 | 7 | 7 | 7 | 7 | 7 |
| | (Sulfur content) | (5.6) | (5.6) | (5.6) | (5.6) | (5.6) | (5.6) |
| | Vulcanization accelerator | 2.5 | 2.5 | 2.5 | 2.5 | 2.5 | 2.5 |
| | TBBS | | | | | | |
| | CTP | 0.4 | 0.4 | 0.4 | 0.4 | 0.4 | 0.4 |
| | Modified phenol resin | 9 | 9 | 9 | 9 | 6 | 15 |
| | Tackirol V200 | 1.2 | 1.2 | 1.2 | 1.2 | 1.2 | 1.2 |
| | HMT | 0.9 | 0.9 | 0.9 | 0.9 | 0.6 | 1.5 |
| Evaluation | E* | 35 | 34 | 36 | 41 | 24 | 49 |
| | Steering response | 6 | 6 | 6 | 6+ | 4 | 6+ |
| | tan δ 70° C. | 0.112 | 0.111 | 0.119 | 0.113 | 0.102 | 0.129 |
| | Rolling resistance | 0 | 0 | 0.2 | 0 | −0.9 | 0.4 |
| | reduction ratio (%) | | | | | | |
| | Durability index | 110 | — | — | — | 115 | 100 |
| | Index of edge smoothness | 115 | 105 | 115 | 120 | 120 | 115 |
| | of extrudate | | | | | | |
| | Index of straightness of | 120 | 105 | 120 | 120 | 125 | 120 |
| | extrudate | | | | | | |
| | Adhesion index | 105 | 102 | 105 | 105 | 110 | 105 |
| | | Examples | | | | | |
| | | 7 | 8 | 9 | 10 | 11 | 12 |
| Composition | NR | 50 | 50 | 50 | 50 | 50 | 50 |
| (part(s) | IR | — | — | 20 | — | — | — |
| by mass) | BR1 (VCR617) | — | — | — | 20 | 50 | — |
| | BR2 (BR150B) | 20 | 20 | — | — | — | 20 |
| | SBR | 30 | 30 | 30 | 30 | — | 30 |
| | Carbon black 1 (EB247) | — | — | — | — | — | — |
| | Carbon black 2 (N351H) | — | — | — | — | — | — |
| | Carbon black 3 (N330) | — | — | — | — | — | — |
| | Carbon black 4 (N550) | 75 | 75 | 75 | 70 | 50 | 75 |
| | Calcium carbonate | — | — | 15 | 15 | 15 | — |
| | Talc | 15 | — | — | — | — | — |
| | Austin black | — | 15 | — | — | — | — |
| | Hard clay | — | — | — | — | — | 12 |
| | Silica | — | — | — | — | — | — |
| | Alkylphenol resin | 3 | 3 | 3 | 3 | 3 | 3 |
| | Antioxidant 6PPD | 1 | 1 | 1 | 1 | 1 | 1 |
| | Stearic acid | 3 | 3 | 3 | 3 | 3 | 3 |
| | Zinc oxide | 10 | 10 | 10 | 10 | 10 | 10 |
| | Sulfur | 7 | 7 | 7 | 7 | 7 | 7 |
| | (Sulfur content) | (5.6) | (5.6) | (5.6) | (5.6) | (5.6) | (5.6) |
| | Vulcanization accelerator | 2.5 | 2.5 | 2.5 | 2.5 | 2.5 | 2.5 |
| | TBBS | | | | | | |
| | CTP | 0.4 | 0.4 | 0.4 | 0.4 | 0.4 | 0.4 |
| | Modified phenol resin | 9 | 9 | 9 | 9 | 15 | 9 |
| | Tackirol V200 | 1.2 | 1.2 | 1.2 | 1.2 | 1.2 | 1.2 |
| | HMT | 0.9 | 0.9 | 0.9 | 0.9 | 1.5 | 0.9 |
| Evaluation | E* | 34 | 26 | 34 | 42 | 43 | 37 |
| | Steering response | 6 | 4+ | 6 | 6+ | 6+ | 6 |
| | tan δ 70° C. | 0.115 | 0.108 | 0.113 | 0.110 | 0.101 | 0.137 |
| | Rolling resistance | 0.1 | −0.2 | 0 | −0.2 | −0.9 | 0.5 |
| | reduction ratio (%) | | | | | | |
| | Durability index | 110 | — | 110 | 115 | 130 | 90 |
| | Index of edge smoothness | 110 | 100 | 125 | 130 | 115 | 110 |
| | of extrudate | | | | | | |
| | Index of straightness of | 125 | 100 | 125 | 135 | 120 | 110 |
| | extrudate | | | | | | |
| | Adhesion index | 110 | 100 | 110 | 105 | 105 | 90 |

TABLE 3

| | | Comparative Examples | | | | | | |
|---|---|---|---|---|---|---|---|---|
| | | 1 | 2 | 3 | 4 | 5 | 6 | 7 |
| Composition | NR | 50 | 50 | 70 | 50 | 50 | 50 | 50 |
| (part(s) | IR | — | — | — | 20 | — | — | — |
| by mass) | BR1 (VCR617) | — | — | — | — | — | — | — |
| | BR2 (BR150B) | 20 | 20 | — | — | 20 | 20 | 20 |
| | SBR | 30 | 30 | 30 | 30 | 30 | 30 | 30 |
| | Carbon black 1 (EB247) | — | — | — | — | — | — | — |
| | Carbon black 2 (N351H) | — | — | — | — | 70 | — | — |
| | Carbon black 3 (N330) | — | 70 | 70 | 70 | — | — | — |
| | Carbon black 4 (N550) | 75 | — | — | — | — | 85 | 38 |
| | Calcium carbonate | — | — | — | — | — | — | — |
| | Talc | — | — | — | — | — | — | — |
| | Austin black | — | — | — | — | — | — | — |
| | Hard clay | — | — | — | — | — | — | — |
| | Silica | — | — | — | — | — | — | 15 |
| | Alkylphenol resin | 3 | 3 | 3 | 3 | 3 | 3 | 3 |
| | Antioxidant 6PPD | 1 | 1 | 1 | 1 | 1 | 1 | 1 |
| | Stearic acid | 3 | 3 | 3 | 3 | 3 | 3 | 3 |
| | Zinc oxide | 10 | 10 | 10 | 10 | 10 | 10 | 10 |
| | Sulfur | 7 | 7 | 7 | 7 | 7 | 7 | 7 |
| | (Sulfur content) | (5.6) | (5.6) | (5.6) | (5.6) | (5.6) | (5.6) | (5.6) |
| | Vulcanization accelerator | 2.5 | 2.5 | 2.5 | 2.5 | 2.5 | 2.5 | 2.5 |
| | TBBS | | | | | | | |
| | CTP | 0.4 | 0.4 | 0.4 | 0.4 | 0.4 | 0.4 | 0.4 |
| | Modified phenol resin | 9 | 9 | 9 | 9 | 9 | 9 | 9 |
| | Tackirol V200 | 1.2 | 1.2 | 1.2 | 1.2 | 1.2 | 1.2 | 1.2 |
| | PK900 | — | — | — | — | — | — | — |
| | HTS | — | — | — | — | — | — | — |
| | HMT | 0.9 | 0.9 | 0.9 | 0.9 | 0.9 | 0.9 | 0.9 |
| Evaluation | E* | 34 | 43 | 41 | 41 | 55 | 48 | 21 |
| | Steering response | 6 | 6 | 6 | 6 | 6+ | 6 | 3 |
| | tan δ 70° C. | 0.112 | 0.154 | 0.156 | 0.155 | 0.167 | 0.149 | 0.101 |
| | Rolling resistance | Baseline | 1.7 | 1.8 | 1.8 | 2 | 1.2 | −0.8 |
| | reduction ratio (%) | | | | | | | |
| | Durability index | 100 | — | — | — | — | 80 | 120 |
| | Index of edge smoothness | 100 | 85 | 100 | 110 | 75 | 70 | 110 |
| | of extrudate | | | | | | | |
| | Index of straightness of | 100 | 105 | 105 | 105 | 90 | 110 | 40 |
| | extrudate | | | | | | | |
| | Adhesion index | 100 | 90 | 100 | 100 | 80 | 70 | 70 |

| | | Comparative Examples | | | | | |
|---|---|---|---|---|---|---|---|
| | | 8 | 9 | 10 | 11 | 12 | 13 |
| Composition | NR | 50 | 50 | 50 | 50 | 50 | 50 |
| (part(s) | IR | — | — | — | — | — | — |
| by mass) | BR1 (VCR617) | — | 50 | — | — | — | — |
| | BR2 (BR150B) | 20 | — | 20 | 20 | 20 | 20 |
| | SBR | 30 | — | 30 | 30 | 30 | 30 |
| | Carbon black 1 (EB247) | — | — | — | — | — | — |
| | Carbon black 2 (N351H) | — | — | — | — | — | — |
| | Carbon black 3 (N330) | — | — | — | — | — | — |
| | Carbon black 4 (N550) | 75 | 35 | 75 | 75 | 75 | 75 |
| | Calcium carbonate | 35 | 15 | — | — | — | — |
| | Talc | — | — | — | — | — | — |
| | Austin black | — | — | — | — | — | — |
| | Hard clay | — | — | — | — | — | — |
| | Silica | — | 15 | 15 | — | — | — |
| | Alkylphenol resin | 3 | 3 | 3 | 3 | 3 | 3 |
| | Antioxidant 6PPD | 1 | 1 | 1 | 1 | 1 | 1 |
| | Stearic acid | 3 | 3 | 3 | 3 | 3 | 3 |
| | Zinc oxide | 10 | 10 | 10 | 10 | 10 | 10 |
| | Sulfur | 7 | 7 | 7 | 7 | 7 | 7 |
| | (Sulfur content) | (5.6) | (5.6) | (5.6) | (5.6) | (5.6) | (5.6) |
| | Vulcanization accelerator | 2.5 | 2.5 | 2.5 | 3.7 | 2.5 | 2.5 |
| | TBBS | | | | | | |
| | CTP | 0.4 | 0.4 | 0.4 | 0.4 | 0.4 | 0.4 |
| | Modified phenol resin | 9 | 15 | 9 | 9 | 9 | 9 |
| | Tackirol V200 | 1.2 | 1.2 | 1.2 | — | — | — |
| | PK900 | — | — | — | — | 2.0 | — |
| | HTS | — | — | — | — | — | 2.0 |
| | HMT | 0.9 | 1.5 | 0.9 | 0.9 | 0.9 | 0.9 |
| Evaluation | E* | 38 | 24 | 36 | 23 | 25 | 22 |
| | Steering response | 6 | 3 | 6 | 3 | 3 | 3 |
| | tan δ 70° C. | 0.135 | 0.091 | 0.152 | 0.138 | 0.141 | 0.144 |
| | Rolling resistance | 0.6 | −0.9 | 1.8 | 0.7 | 0.7 | 0.8 |
| | reduction ratio (%) | | | | | | |
| | Durability index | — | — | — | — | — | — |
| | Index of edge smoothness | 100 | 110 | 100 | 100 | 100 | 100 |
| | of extrudate | | | | | | |
| | Index of straightness of | 105 | 60 | 50 | 95 | 95 | 95 |
| | extrudate | | | | | | |
| | Adhesion index | 95 | 95 | 75 | 90 | 100 | 100 |

In the Examples in which a carbon black having a specific BET specific surface area, an inorganic filler other than silica, and a phenolic resin were used, the handling stability, fuel economy, and extrusion processability were improved in a balanced manner. In the Examples in which calcium carbonate was used as the inorganic filler, and the Examples in which IR or VCR was used for the rubber component, the handling stability, fuel economy, and extrusion processability were significantly improved, and also the durability was excellent.

1. A rubber composition for a bead apex, comprising:
a rubber component;
carbon black;
an inorganic filler other than silica; and
a phenolic resin,
wherein the carbon black has a BET specific surface area of 25 to 50 m²/g, and
an amount of the carbon black is 40 to 80 parts by mass, and an amount of the inorganic filler is 3 to 30 parts by mass, based on 100 parts by mass of the rubber component.

2. The rubber composition for a bead apex according to claim 1, further comprising:
an alkylphenol-sulfur chloride condensate represented by formula (1): 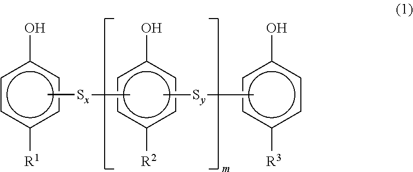
wherein R¹, R², and R³ are the same as or different from one another, and each represent a C₅₋₁₂ alkyl group,
x and y are the same as or different from one another, and each represent an integer of 1 to 3, and
m represents an integer of 0 to 250.

3. The rubber composition for a bead apex according to claim 1,
wherein the inorganic filler has an average particle size of 100 μm or smaller.

4. The rubber composition for a bead apex according to claim 1,
wherein the phenolic resin is a phenol resin and/or a modified phenol resin.

5. The rubber composition for a bead apex according to claim 4,
wherein a total amount of the phenol resin and modified phenol resin is 5 to 18 parts by mass based on 100 parts by mass of the rubber component.

6. The rubber composition for a bead apex according to claim 1,
wherein a total amount of the carbon black, the inorganic filler, and silica is 50 to 120 parts by mass, a sulfur amount is 4 to 8 parts by mass, and an oil amount is not more than 5 parts by mass, based on 100 parts by mass of the rubber component.

7. A pneumatic tire, comprising:
a bead apex produced from the rubber composition according to any one of claims 1 to 6.
